(19) United States
(12) Patent Application Publication
(10) Pub. No.: US 2003/0069878 A1
(43) Pub. Date: Apr. 10, 2003

(54) Data search by selectable pre-established descriptors and categories of items in data bank

(76) Inventor: Gidon Wise, New York, NY (US)

Correspondence Address: David M. Warren, 655 Oakland Ave., Cedarhurst, NY, 11516, US

(21) Appl. No.: 09/908,125

(22) Filed: Jul. 18, 2001

(51) Int. Cl. G06F 7/00

(52) U.S. Cl. 707/3

(57) ABSTRACT

A searching process employs an organization of data, in terms of categories, descriptors and identities of various items, which is stored in a data bank. To search for one of the items, there is a selecting of a plurality of categories drawn from the stored categories in any of a plurality of orders to produce a sequence of categories, of which at least one category relates to descriptors of the object. In the sequence of categories, there are at least two sequential categories of which a latter category restricts a range of object descriptors of a former category by a Boolean intersection. Available categories for use in the search are displayed in a list, and a category which represents a null set of object descriptors is withdrawn from the list. Negation and OR functions are provided.

### BACKGROUND OF THE INVENTION

This invention relates to organization of data by means of categories and descriptors and, more particularly, to establishment of a search for data by selection of categories and descriptors of the data.

Search engines are often employed to obtain information, such as a passage in a document, the weather at a distant location, or instructions for accomplishing some task, by way of example. Many people have access to use of a search engine via the Internet. The operation of a search engine, as well as the procedure for its use, may depend on the situation in which it is employed. By way of example, to identify a document having a specific word or grouping of words, a group of words or words in combination with Boolean operators may be entered into the search engine. The search may be refined by further entry of words or groups of words to obtain the desired documents. In the case of a request for the weather at a distant location, one may enter the name of a country, and then be required by the search engine to enter the name of a city or other geographic subdivision of the country. Furthermore, in the case of a request for instructions for accomplishing a task, such as the building of a house, one may be directed to choose among various categories such as a stone house or a log cabin, a required choice which may be confusing for someone who is seeking data on the painting of an interior surface. Often, when one employs a search engine, it is not clear at the outset what kind of prompts may have to be entered into the engine, and there is frequently the possibility that the path of a search may lead to a dead end in which one is unable to obtain the desired information. In that case the person may have to redo the search by use of different prompts. Depending on the subject matter of the search, such prompts may include the color of clothing, kinds of food, modes of transportation, as well as dates and locations, by way of example.

A major problem in the design of a search engine is the choice of a mode of organization of the data and the various categories, or other tools, which may be employed to access the data. This can be demonstrated by the simple example of a telephone book providing the telephone numbers of numerous persons. The entries in the telephone book may be organized in alphabetic fashion, such organization being useful in the case where one knows how to spell the name of the person being sought. However, if one does not known the name of the party being sought, but knows only the party's occupation or business such as a plumber, then one must use a different form of telephone directory in which the parties are listed under various categories in the conduction of business. This, in turn, creates a problem of a proper selection of categories, such as sales, service, repair and manufacturers, by way of example, particularly if the plumbing was required in a specific situation such as on board a ship.

In order to treat this problem, search systems have been developed to handle specific situations, such as a search for identification and treatment of various diseases in a medical data base. However, it is clear that such a search system or procedure might not be optimal for a searching for records in sporting events nor in planning transportation for persons on tour. Many of the well-known search engines available to people using the Internet may be regarded as a compromise between a system of organizing data in a fashion which will be useful to people in a general way, and a system which does not require excessive amounts of storage of categories and relationships in the conduct of searches. As a result, a user of the engine may be lucky or unlucky in the attainment of the desired data because of a chance selection of categories and subcategories. Once the user has progressed on one of many possible branches in a map of the search process without success, there is little choice but to keep notes of the progress so as to avoid future missteps, and to initiate a new search on some other branch of the map.

### SUMMARY OF THE INVENTION

The aforementioned disadvantages are overcome and other benefits are provided by an organization of data, in terms of categories and descriptors of various items, for storage in a data bank, and the utilization of the categories and descriptors in a process of search, in accordance with the invention. There are two aspects to the invention, namely, the storing and the utilization of data useful in the conduct of a search. The data to be used in the conduct of the search concerns a set of categories and descriptors of numerous items in the data bank, as well as relationships among various ones of the categories and relationships among various categories and descriptors. The various categories and the various descriptors are chosen on the basis of utility in describing the various items in the data bank, and additional categories and descriptors may be provided upon addition of other items in the data bank.

The foregoing relationships serve to associate various ones of subcategories with a category as well as to associate various ones of descriptors with a subcategory. In the conduct of a search, the user of a search engine constructed in accordance with the invention chooses a category followed by a choice of a further category or subcategory. The results of a succession of steps in the conduct of a search may be described by a map wherein the various steps of the search have the appearance of the branch of a tree with little branches protruding from a main branch. Such a map may be suggestive of a hierarchical category system except that, with the map of a search conducted with the invention, the succession of branches is not predetermined but, rather, is established by the person conducting the search. By virtue of the invention, the person is able to monitor progress in the conduct of the search, by use of a display presenting the selected categories, and to reuse various categories as well as to use new categories and descriptors as may be desired.

The map consists of nodes connected by links, wherein a node represents a state in the search in which a particular category or descriptor is being employed, and a link represents a transition to the next state wherein a successor category or descriptor is employed. To facilitate a description of the invention, it is useful to adopt the nomenclature wherein the node at the beginning of a link is said to represent a parent category and the node at the end of the link is said to represent a child category. In the map, the association of a plurality of the aforementioned subcategories with a category would be represented by a single node for a parent category connected by plural links to respective ones of the plurality of nodes representing the child categories.

In terms of displaying the nodes of the map for a viewing by the person conducting the search, it is advantageous to display various ones of the parent and child categories currently under consideration by the searcher as well as some of the previous categories which were displayed. As the search continues, the display is updated. This enables the searcher to evaluate progress in the conduct of the search. It also informs the searcher as to what categories are available to be imposed on the search. Also, it is advantageous to present an updated listing of the items which meet the conditions of the search. As the search progresses, the effect of the successive steps is to narrow the range of items which contain that item or items that the searcher seeks.

The constraints employed by imposition of the various categories on the selection of the items may be described mathematically as the Boolean intersection of the sets of items dictated by each of the categories. A feature of the invention in the displaying of child categories is the avoidance of any child category which has a null set of the items being sought. This avoids a useless search. The searcher may choose from any of the numerous categories in any order, may deselect a category, and may back up to a previous category for maximum agility in navigating the map and developing a set of constraints on the search to obtain the desired item or items from a multiplicity of items carried in the data bank.

The foregoing results are obtained in a surprisingly simple fashion of tabulating data consisting of items that may be objects of the search with corresponding descriptors of the items in a first table. Also tabulated, in a second table, are the links among categories and the descriptors, as well as links among the categories and subcategories in terms of parent-child relationships, the second table representing a hierarchy of linkages among categories and/or descriptors useful in describing the various items. Since many items share descriptive categories, such as location, style, medium, by way of example in a listing of art objects, this form of tabulation reduces the number of entries to an amount which is readily searchable by a search engine.

In the user-engine interface, when the searcher selects a term for initiating the search, which term may be referred to as the top category (located at the top or beginning of the map), such as a work of art, this category becomes the first node of the map. The engine then treats the selected category as the parent category and proceeds to display all of the child categories listed in the second table. The searcher might then continue the search via the “medium” category which would lead into considerations of oil and pastel, by way of example. However, at any time during the search, the searcher can always narrow the search by proceeding further via the unused categories “location” and “style”. Thus, a category is always available to narrow a search, even though it may have appeared previously on the map and was not selected at the time of its initial appearance. When the user selects a category, which category is then treated by the engine as a parent category, the engine proceeds to display all the corresponding child categories from the second table, with the exception of any child categories for which there are no items to be found in the search. This exclusion of a child category is determined by the engine via a search of the items listed in the first table.

The invention, therefore may be expressed as a sequence of method or process steps. The steps would be carried out with the aid of a computer having a memory (or connection to a distant memory) for storing data, a display driven by the computer to present information to facilitate conduction of the search, and a keyboard and mouse by which the searcher enters requests into the computer. More specifically, the invention may be described as follows.

A process for navigating through a set of categories of data in the conduction of a search for identifiable items, comprising the steps of:

storing identities and descriptors of items to be accessible by a search, the storing establishing a first set of relationships between the items and their respective descriptors;

establishing a second set of relationships which serves to relate individual ones of the data categories to each other and to the descriptors hierarchically;

displaying a listing of available selections, said selections being drawn from said categories and said descriptors; and

implementing a sequence of said selections in any one of a plurality of orders to obtain the identity of at least one of said items.

The foregoing sequence of steps may be likened to a tree wherein the descriptors would be the leaves, some of the data categories would be small branches which link together the leaves, and other ones of the data categories would be large branches which link together the small branches. This hierarchical arrangement can be continued with still further data categories which, continuing with the analogy of the tree, may be likened to larger branches connecting with the trunk of a tree. One can also speak of levels in the hierarchical arrangement of the categories, wherein a first level of categories is analogous to the larger branches which connect with the trunk, and a second level of categories is analogous to the smaller branches which connect with the larger branches.

By analogy with the tree, in the practice of the invention, first the hierarchical arrangement of categories, subcategories and descriptors is established, and thereafter, the sequence of search steps begins with the tree trunk, or large branch depending on the complexity of the hierarchical arrangement, and proceeds to a selection of one or more descriptors. The search need not end at this point because the invention permits the searcher, at any point in the search process, to select another category, even one which was previously selected, to continue in search of a suitable one of the items listed in the data bank. For example, in the sequence of selections, the searcher may have selected the category of color followed by a selection of the descriptor “blue”. Later, if too many blue objects are found, the searcher may again select the category of color followed by a selection of the descriptor “white” to obtain a listing of objects having coloring of both blue and white.

For storing the properties of the various items, one first determines what properties would be useful in the conduct of the search. For example, if the object of the search is a work of art, as distinguished from a racing car or a mountain-climbing expedition, then the development of a map of the search would begin at the root of a tree with a category or subject dealing with a work of art. By way of example, one such work of art might be a sculpture carved from wood, painted with various colors, and manufactured in a specific state or other location. The sculpture might be as large as a man, or relatively small such as the size of a shoe, and might depict subject (yet another category) which is an historical scene or a person or an animal. All of the foregoing descriptive terms may be regarded as properties or descriptors of the work of art which would be useful to a searcher in finding a work of art suitable to his or her taste. Accordingly, there would be stored an identifying name of the work of art, as well as the various properties of the work of art, namely, that the work of art is a sculpture, that it is made from wood, a listing of colors used in painting the work, the state of manufacture, the size of the work, and the subject matter of the work.

Categories are established relating to the foregoing properties. Categories of color and size would be useful whereby, for example, upon a selecting of the color category by the searcher, there would appear the colors in this work of art as well as colors that may be present in other works of art for which data is stored in the data bank. Thus, all of the colors can be grouped under one category. The categories of color and size might be grouped together as subcategories of a category providing various features of the work of art. The various relationships of parent-child among the categories are stored in the data bank. The medium of the art, such as sculpture or oil painting or pencil drawing by way of example, would be a useful category that would enable the searcher to indicate a preference for the sculpture. It is noted that a selection of the medium by the searcher before a selection of the color would affect the outcome of the color selection. Upon a selecting of the searcher's favorite color, the name of the sculpture would be listed on a display showing the progress of the search if the color were present in the work, and if the searcher had selected the medium of sculpture. However, if the searcher would have previously selected the medium of oil prior to selection of the desired color, then the names of oil paintings having this color would be listed on the display.

As an important feature of the invention, it is noted that in the selecting step, the searcher can select from a plurality of categories drawn from all of the listed categories in any desired order to produce a sequence of categories, wherein at least one category of the sequence of categories relates to properties of the object. As a convenience in the use of the listing of available categories, the listing of available categories is updated to show which of the available categories have been selected and are currently in use. By way of example, an indication of the categories currently in use can be presented on the display by application of a color or different degree of brightness to the selected categories, or by listing the selected categories in a window of the display.

A further advantageous feature is an indication of a null category which may come about as the sequence of selected categories develops. For example, if the data bank provided for works of art constructed in New York, Pennsylvania, and Connecticut, then a parent category of location would have these three states as child categories. The parent and the three child categories would be presented via the display to the searcher as being available for the conduct of the search for a suitable work of art. Let it be assumed further in this example that the searcher has already selected a subcategory of art identified as wood carvings, but that the wood carvings are available only in Pennsylvania. Then the presentation of the map of the categories would include an indication that the child categories of New York and Connecticut are null categories, so that the searcher would not waste time looking in these states for wood carvings.

The searching through the data bank to find categories and properties of an object, as requested by the searcher, is readily accomplished by a computer that is suitably programmed to read the stored data, to present results of a searcher's request on the display, and to withdraw categories for which no data is found. The storage of the data, the computer, and the display can be located at a common location or, alternatively, the data storage can be located remotely from the display (and also from the searcher) as would be the case in which the searcher communicates via the Internet with a web site wherein access is provided to the data storage. With either configuration of the equipment, the searcher is able to assess the outcome of the successive approaches with the capacity to devise still further approaches that lead to an item or a plurality of items being sought by the searcher.

Two other features may be useful under certain circumstances, and are provided by the invention. By way of example, in the foregoing situation where the searcher is looking for a painted sculpture, and has selected the color blue because it matches with other objects in a room which the searcher is decorating, some of the items which are found include additional colors, such as red, which would not blend in with other colors in the room. Accordingly, during the conduct of the search, the invention allows the searcher to select the category of color followed by the subcategory of red, plus the capability to negate the red color by entering the word “NOT”. This reduces the listing of available candidate items by excluding from the list all sculptures for which the data bank has listed the presence of red coloring.

As a further example, the searcher who is looking for a cool color for the subject, may have noticed that the number of available sculptures with blue coloring is overly limited, and decides it would be advisable to include also green as an acceptable color. Accordingly, during the conduct of the search, the invention allows the searcher to select the category of color followed by the subcategory of blue and the further subcategory of green by entering the word “OR”. The search engine responds by listing those sculptures for which the data bank shows an entry of blue coloring or green coloring or both blue and green coloring. Also, as described above with reference to the mathematical description of the Boolean intersection of the sets of items dictated by each of the categories, the invention can provide the Boolean AND function. Thereby, the invention employs the Boolean OR function to enlarge the area of search (such as allowing for blue or green or both blue and green to be present in the sculpture), as well as the Boolean AND function to narrow the area of the search (such as requiring that both blue and green be present in the sculpture).

### BRIEF DESCRIPTION OF THE DRAWING

The aforementioned aspects and other features of the invention are explained in the following description, taken in connection with the accompanying drawing figures wherein:

FIG. 1 shows diagrammatically apparatus for the storage and searching of data in accordance with the process of the invention;

FIG. 2 shows diagrammatically apparatus, similar to that of FIG. 1, wherein the data is stored as a location distant from a display employed by a searcher;

FIG. 3 shows a diagram, in the form of a tree, presenting an arrangement of categories available for selection by a searcher during the progress of a search;

FIG. 4 is a chart showing the progress of a searcher in navigating through a succession of categories in a search;

FIG. 5 is a flow chart showing operation of a computer in searching the properties of various items for which information is available in a data bank; and

FIG. 6 is a flow chart showing operation of the computer in accomplishing searches in the flow chart of FIG. 5.

Identically labeled elements appearing in different ones of the figures refer to the same element but may not be referenced in the description for all figures.

### DETAILED DESCRIPTION OF THE INVENTION

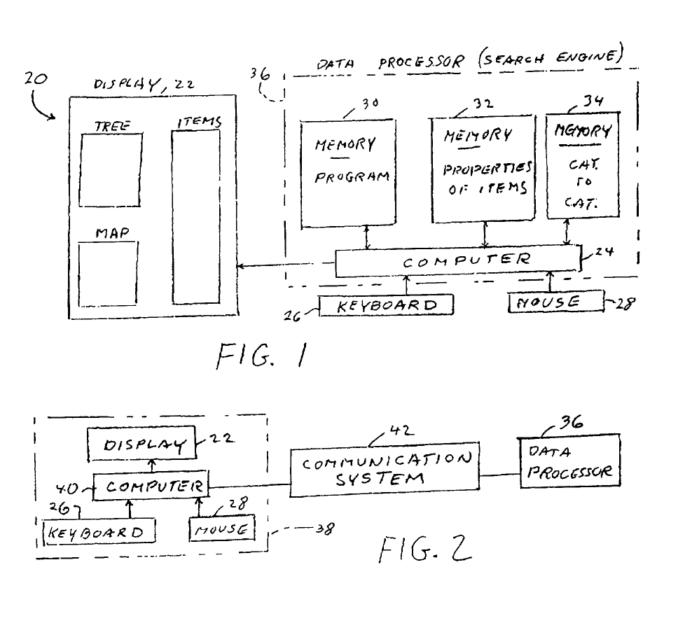

With reference to FIG. 1, there is shown a search station 20 wherein a searcher can conduct a search employing the procedure of the invention. The search station 20 has a display 22 driven by a computer 24, with access to the computer by the searcher being provided by a keyboard 26 and a mouse 28. Data storage is provided for the computer 24 and, to facilitate explanation of the invention, is represented by three memories 30, 32, and 34, it being understood that a single larger memory could be employed if desired. The three memories are shown connected to the computer 24. The memory 30 stores an operating program which enables the computer 24 to perform the functions needed for carrying forth the search and data storage functions of the invention. The memory 32 stores the properties and the identities of the items for which a search may be conducted. The memory 34 stores the categories and the relationships of parent-child among the categories and between the set of categories and the set of properties of the various items. The computer 24 and the memories 30, 32, and 34 constitute a data processor 36. The computer 24 presents data of the search to the display 22 for viewing by the searcher. Commands by the searcher to the computer 24 for the conduct of the search are entered via the keyboard 26 and/or via the mouse 28.

The presentation of data on the display 22 may be provided by a plurality of windows. It is noted that an arrangement of windows is employed frequently for presentation of data from an Internet web site or by an Internet Service Provider. In the display 22 it is advantageous to provide three windows, as shown in FIG. 1, wherein one of the windows presents items meeting the limitations established by the categories which have been selected already by the searcher, a second of the windows presents graphically (preferably in the form of a tree) the categories available for choosing by the searcher, and the third window presents a map of the categories already selected by the searcher. The three windows collectively show the searcher the progress of the search and options for altering the direction of the search.

FIG. 2 shows a search station 38 which is a modification of the search station 20 of FIG. 1. In FIG. 2, the search station 38 includes the display 22, the keyboard 26 and the mouse 28 which operate with a computer 40. The computer 40 drives the display 22 in response to commands entered into the computer 40 by the keyboard 26 and the mouse 28. However, the data processor 36, which stores and manages the data needed for conduction of the search, is provided at location distant from the search station 38, and communicates with the search station 38 by a communication system 42. The communication system 42, by way of example, may be a telephone system or high speed Internet channel, and access to the data processor 36 may be via communication with an Internet web site. Data for presentation on the display 22 is communicated via the communication system 42 between the two computers 24 and 40. The computer 40 is programmed to perform its tasks of entry of data and commands provided by the keyboard 26 and the mouse 28, and to communicate data and commands with the computer 24 of the data processor 36.

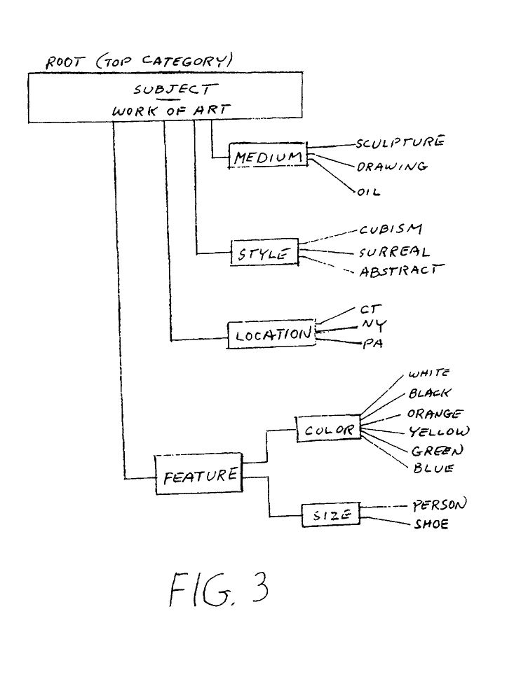

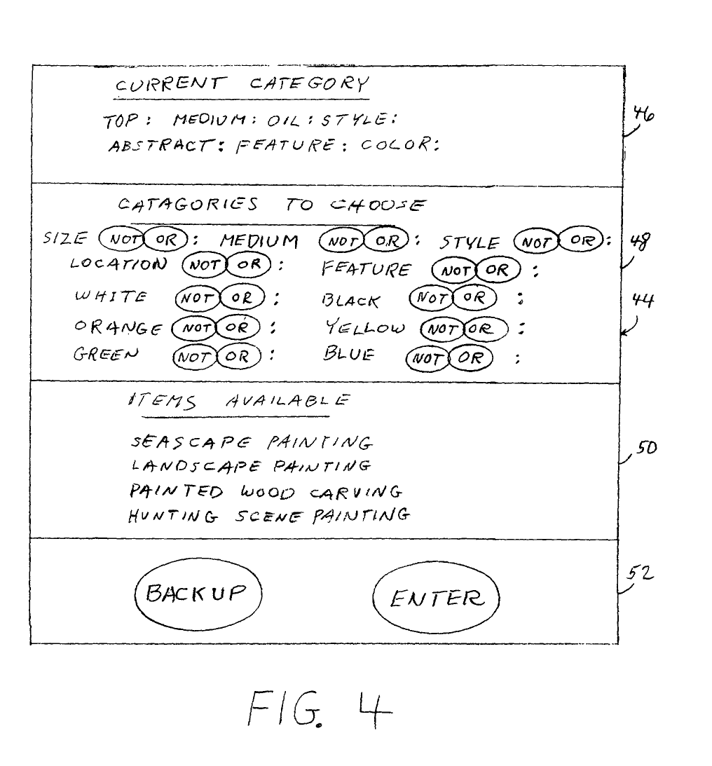

FIG. 3 shows, by way of example, one possible arrangement of the categories available to the searcher, which arrangement is to be presented on the display 22 (FIGS. 1 and 2). The arrangement of FIG. 3 is analogous to a tree wherein the category at the top of the arrangement would be at the root of the tree, and other ones of the categories are located in branches of the tree. It is advantageous if the complete tree can be presented on the display 22, however, in the case of a tree having many branches with many categories, it may not be possible to present all of the categories concurrently on the display 22, in which case a display technique, such as scrolling, may be employed advantageously to enable the searcher to become familiar with the entire tree. To facilitate an understanding of the diagram, the categories are presented in rectangular blocks, while no blocks are used for the properties of the items described within the memory of the search engine.

The data processor 36 of FIGS. 1-2 functions as a search engine. In the example presented in FIG. 3, the searcher has already selected a subject of the search, the subject being a work of art. This subject is one of many subjects handled by the search engine, and is shown to the searcher via a list of subjects presented on the display 22. The searcher has indicated to the search engine the choice of the work of art by clicking with the mouse on this subject in the list, or by typing in the subject in a data entry window (not shown in the drawing) located in the display 22. It is to be understood that the mode of indication of choice of subject is presented by way of example only, and that other modes of communication of a choice, such as by speech recognition may be employed.

The data presented in FIG. 3 is stored in the memory 34 which, as noted above, stores the various categories, the parent-child relationships among the categories, and the parent-child relationships among various ones of the categories and properties of items listed in the memory 32. The top category is a work of art, and has as its child categories: (1) the medium from which the work is formed, (2) the style of the work, (3) the location of the work, and (4) a distinguishing feature of the work. The feature category has subcategories, or grandchildren of the top category, which are colors employed in the work and the size of the work. By way of example of the various works which may be available to the search engine, the category of the medium has subcategories which may also be regarded as properties of the individual works of art, namely, that a work of art may be a sculpture, or a drawing, or a work in oil such as an oil painting. Similarly, the subcategories of style may also be regarded as properties of the works of art, namely, that a work of art may be in the form of cubism, may have a surreal style, or may be abstract. The subcategories of the location category allow a searcher to select art from any one of three states. In similar fashion, various colors found in the works of art are shown as children of the color category, and two sizes of a work are presented by way of example, namely, the size of a person or the size of a shoe.

In accordance with a feature of the invention, the searcher may select a property, such as a color, or negate a specific color. For example, the searcher may be looking for a painting having cool colors of the spectrum such as green and blue, but that there should be no black color in the painting. After selecting sequentially the top category followed by the feature category, and then the color category followed by the color green, there would be presented to the searcher a list of all the works of art that have some green color. The searcher may then limit the number of works in the list by selecting the medium category followed by the category of oil painting. The list presented to the searcher is reduced in size to show only oil paintings having some green paint therein.

The searcher may then request data on individual ones of the works of art in the list, and discover that some of the paintings have, in addition to the green paint, also some black paint which is not desired. The searcher then selects again the category “color” followed by the category “not black” which results in a still further shortening of the list of acceptable works of art to show only oil paintings having some green color, but no black paint. FIG. 3 does not show the category “not black” in order to simplify the drawing. However, this category may be implemented by including the term “not” alongside each color or may be implemented by pressing a specific key, such as the letter “n” on the keyboard at the time of selection of the color black, by way of example. By way of further example, in the situation wherein the computer 24 (FIG. 1) responds to voice commands, the searcher may speak the word “not” to establish the negation of a category.

In the foregoing example of the negation of a category, the searcher had already selected the color green and, subsequently, again selected the category “color”. This signaled the data processor 36 to provide the Boolean function of “AND” wherein the requirement of one color is to be combined with another color requirement. Upon the selection of the “not black” limitation, the data processor 36 then added a further restriction to the search and removed from the listing of paintings with green color all those paintings having black coloring. If desired, the searcher can again impose the Boolean AND function on the color of the painting, for example, by requesting paintings having both green and blue, but no black. This is accomplished by selecting again the color category followed by selection of the color blue.

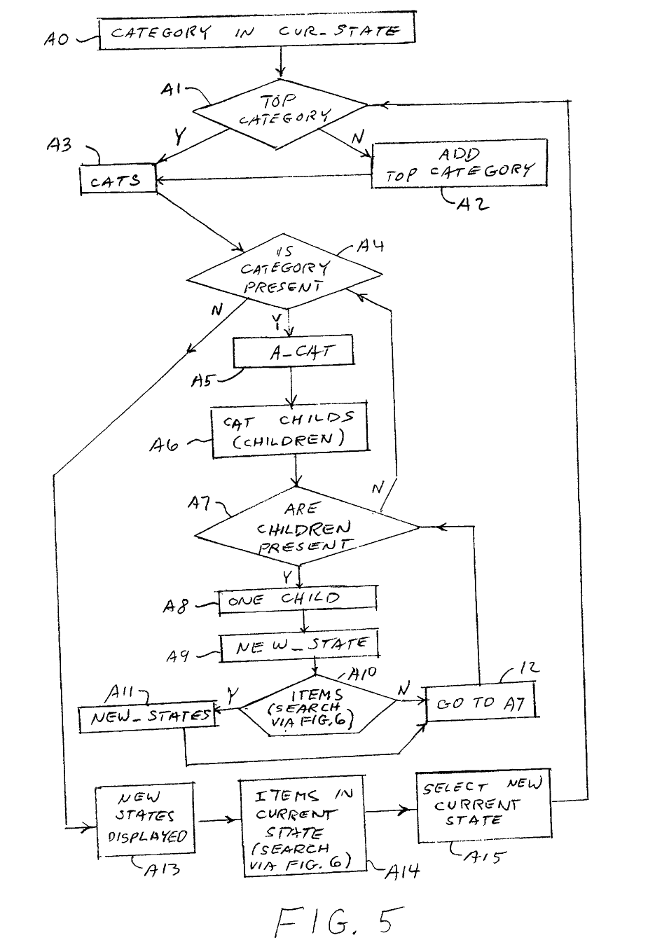

FIG. 4 presents a chart 44 which is suitable for presentation on a display such as the display 22 of FIG. 1 to show a researcher categories which have been selected as well as categories which are available for selection. The chart is divided into an upper section 46, a middle section 48, and a lower section 50. The most recent, or current, category that has been selected, as well as preceding ones of the selected categories are presented in the upper section 46. The current category and the preceding selected categories are arranged in a sequence, separated by indicia such as colons, by way of example. The sequence of categories may be regarded as a map, beginning with the top category and ending with the current category, to present a path or history in the conduct of the search. The top category is in reference to the work of art presented at the top of FIG. 3, and the current category is shown, by way of example, as the “color”. In this example, after selecting the top category, the searcher selected the category of “medium” followed by the category of “oil”, and then selected “style” followed by “abstract”, and then continued with the categories of “feature” and its subcategory of “color”. While the representation of the categories in the upper section 46 is in a textual form, rather than the graphical form of FIG. 3, the textual form of FIG. 4 has the advantage of a more compact format for presentation on a display, and possesses the additional advantage of showing readily when a searcher has revisited one or more of the categories.

The middle section 48 presents a current listing of categories which are available to the searcher to make a selection. The categories shown, namely, “size”, “medium”, “style”, “location” and “feature” plus a listing of several colors correspond to the current category “color” shown in the upper section 46. Individual ones of the colors may be found in one or more of the works of art. At the beginning of the selection process, the categories of medium, style, location and feature were available. After the selection of “medium”, the categories of style, location and feature were still available for selection, as well as the categories (or properties of the items) sculpture, drawing and oil. Thus, the listing presented in the middle section 48 continually changes with each new selection of a current category. The upper section 46 and the middle section 48, taken together, may be regarded as a form of map which informs the searcher as to where the searcher has been and to where the searcher may go.

The lower section 50 presents a listing of items available to the searcher, one or more of which items may be the object of the search. While, in practice, the list of available items may be lengthy, four items are presented in FIG. 4, by way of example, these items being a seascape painting, a landscape painting, a painted wood carving, and a painting of a hunting scene. Since these items became listed by virtue of the limitation “oil” following the “medium” category, it is understood that all or at least some of the paint used in each of these items is an oil-based paint. Also, each of these works of art is understood to be in the abstract style because the searcher has indicated a preference for the abstract style in the upper section 46 of the chart 44. Had the searcher indicated some other style of art, such as “surreal”, a different set of items would be listed in the lower section 50. Thus, the presentation of the chart 44 of FIG. 4 provides both the history, the choice of further categories, and the items available corresponding to the limitation presented by the history of categories. Therefore, the chart 44 is suitable for presentation in a display, such as a display 22, for aiding the searcher.

By way of alternative environments of the invention, with reference to the display 22 of FIG. 1, the “TREE” window may have both the diagram of FIG. 3 and the middle section 48 of FIG. 4 to show the overall arrangement of categories, as well as categories available for choosing by the searcher. The “MAP” window may show the upper section 46 of FIG. 4 to show the categories already selected by the searcher. The “ITEMS” window may display the listing presented in the lower section 50 of FIG. 4 to present those items meeting the limitations established by the categories which have been selected by the searcher.

Also shown in the middle section 48 of the chart 44 of FIG. 4 is the word “NOT” and the word “OR” appearing after each of the respective categories and the descriptors (colors) listed in the middle section 48. Each word “NOT” and each word “OR” is presented on the display 22 in the form of a soft button upon which a searcher can place the cursor of a mouse for clicking on either or both of the “NOT” and the “OR” for selecting the NOT and/or OR functions. Also provided at a location of convenience, such as at a bottom section 52 of the chart 44, are two soft buttons, identified as “ENTER” and “BACKUP”, each of which can be selected by clicking with the cursor of the mouse. The searcher can select items having one of the listed colors, by clicking with the mouse on the desired color, and then clicking on the ENTER button. Alternatively, to select items in which that specific color is absent, the searcher selects both the specific color and the NOT button following the selected color, and then clicks on ENTER. For example, if the searcher selects the color green, then the listing of available items is reduced to show only those items in which the color green is present. If, after the selection of the color green, the negation of the color black is selected, then the listing of available items is reduced to show only those items in which the color green is present, and the color black is absent.

As an example in the use of the OR function, the searcher may have already proceeded with the search by selection of various categories, such as location, medium and style to obtain a wooden sculpture. The searcher desires now to limit the search further by seeking a sculpture for which the data bank lists either the color green or black or both of the colors green and black. Accordingly, by use of the mouse, the searcher selects the color green, selects also the OR button following the color green, and further selects the color black. After reviewing the selected items for accuracy, the searcher then clicks on ENTER to transmit a command to the search engine to conduct a search of the data bank to identify which of the sculptures have the designated colors of green or black or both green and black. In the event that the searcher notices an error in the selection, prior to selection of ENTER, the searcher can deselect the erroneous entry by again clicking on the erroneous entry, and then clicking on the correct entry.

As a variation in the foregoing example in the use of the OR function, the searcher may have limited the search to sculptures having green coloring, and finds that the choice of available sculptures is too small. The searcher wants to enlarge the search to include also sculptures for which the data bank lists the color black. This is accomplished by again selecting the category “color”, selecting ENTER which results in a listing of available colors, then selecting “green” and “black” along with OR, followed by ENTER. The display then shows the sculptures having green or black or both green and black.

By way of alternative procedure, it is noted that computer operating systems enable a user of the computer to select items by a clicking with the mouse on the display, as described above, or alternatively, by pressing the enter key or special function key on the keyboard 26 (FIG. 1). Therefore, in the practice of the invention, keys on the keyboard may be used for selection of the foregoing functions of NOT and OR, such as by using the letter n for the function NOT and the letter r for the function OR. Also, it is noted that the words appearing in the chart 44 (FIG. 4) are arranged in successive lines which permit the use of the cursor keys of the keyboard to position the cursor in the right/left and up/down directions. Thus, as an alternative to use of the mouse, the searcher may employ the cursor keys in combination with the shift key to select categories and functions.

A further convenience function is provided by the BACKUP button on the chart 44. The searcher might obtain an unanticipated result at some point in the search, and conclude that it would be advantageous if the previous search request could be disregarded, and that the present state of the search could revert to the preceding state of the search. The searcher selects the BACKUP button, and then selects ENTER to command the system to revert to the previous state of the search. The BACKUP function is implemented by operation of the computer 24 (FIG. 1) to store the present wording of the chart 44, in response to the ENTER command, prior to advancing to the next stage of the search. Since the wording of the chart 44 has been saved, the searcher can revert to the former wording of the chart 44 and the corresponding state of the search.

There follows an example of six works of art for which data is to be stored in the memory 32 (FIG. 1) of the data processor 36, and for which links between categories are to be stored in the memory 34 of the data processor 36. The first work of art is referred to as Still Life Abstraction, is an oil painting made in Connecticut, is in the abstract style, has as its main colors yellow, orange and white, and has the size of a person. The foregoing information about the Still Life Abstraction is presented in the first seven lines of Table 1A.

In accordance with a feature of the invention, it is recognized that it may be useful to the searcher, at various times during the search process and including the inception of the search process, to be able to view a listing of all the works of art that can be accessed by the tree of FIG. 3. This is accomplished by placing additional information in Table 1A. For example, the eighth line of the table shows a relationship between the Still Life Abstraction and the category “medium” of FIG. 3. This enables the search engine to list the Still Life Abstraction in the lower section 50 of the chart 44 in FIG. 4 when the searcher selects the category “medium”. By way of further example, the search engine can be made to list the Still Life Abstraction in the lower section 50 of the chart 44 when the searcher selects the category of “location” or “size” in the tree of FIG. 3 by entering the relationships between the Still Life Abstraction and the categories of “location” and “size” as shown in the ninth and the tenth lines of Table 1A. If desired, the search engine can be made to present the Still Life Abstraction in the lower section 50 of the chart 44 at the inception of the search when the searcher selects the “top” category, by listing “top” in the table as shown at the last line of Table 1A. If many items are present in the list of available items in the chart 44, it may be necessary to scroll through the list. If an excessively large number of items (possibly over a thousand) are present, the computer 24 can be programmed to present the message “over a thousand items” in the cart 44 to alert the searcher to the presence of a large number of items. The data to be stored in the memory 32 is tabulated in Table 1A as follows:

TABLE 1A

| ITEM | DESCRIPTOR |
|---|---|
| Still Life Abstraction | oil |
| Still Life Abstraction | Connecticut |
| Still Life Abstraction | abstract |
| Still Life Abstraction | yellow |
| Still Life Abstraction | orange |
| Still Life Abstraction | white |
| Still Life Abstraction | person |
| Still Life Abstraction | medium |
| Still Life Abstraction | location |
| Still Life Abstraction | size |
| Still Life Abstraction | top |

The corresponding data to be stored in the memory 34 includes the relationships among the categories shown in FIG. 3, which are presented in the first six entries of Table 1B, plus the relationships among various ones of the subcategories of FIG. 3 and the descriptors for the Still Life Abstraction, shown in the remaining entries of Table 1B. The data to be stored in the memory 34 is tabulated in Table 1B as follows:

TABLE 1B

| PARENT CATEGORY | CHILD CATEGORY |
|---|---|
| top | medium |
| top | style |
| top | location |
| top | feature |
| feature | color |
| feature | size |
| medium | oil |
| location | Connecticut |
| style | abstract |
| color | yellow |
| color | orange |
| color | white |
| size | person |

The second work of art is referred to as Bust of Napoleon, is a sculpture made in Pennsylvania, has the color white, and is the size of a shoe. The information describing the second work of art is placed in the data processor 36 (FIG. 1) by the insertion in the memory 32 of additional data of the descriptors, as shown below in Table 2A and additional data in the memory 34 of the relationships among subcategories and the descriptors as shown below in Table 2B. Also, in order to have the Bust of Napoleon listed on the chart 44 upon a selection of various ones of the categories in the tree of FIG. 3, such as the categories of size, color, medium and top, these four additional relationships are presented in the bottom four lines of Table 2A. Therefore, after entry of the information for the first two works of art into the data processor 36, the data stored in the memory 32 includes the total of the entries of Tables 1A and 2A, and the data stored in the memory 34 includes the total of the entries of Tables 1B and 2B. The additional data is tabulated as follows:

TABLE 2A

| ITEM | DESCRIPTOR |
|---|---|
| Bust of Napoleon | sculpture |
| Bust of Napoleon | Pennsylvania |
| Bust of Napoleon | white |
| Bust of Napoleon | shoe |
| Bust of Napoleon | size |
| Bust of Napoleon | color |
| Bust of Napoleon | medium |
| Bust of Napoleon | top |

TABLE 2B

| PARENT CATEGORY | CHILD CATEGORY |
|---|---|
| medium | sculpture |
| location | Pennsylvania |
| size | shoe |

It is noted that the number of entries for the links among categories, presented in Table 2B is less than the number of entries (first four lines) in Table 2A because the link between the subcategory “color” and the descriptor “white” for FIG. 3 has already been constructed by an entry in Table 1B. After information for many objects has been entered into the memories of the data processor 36, relatively few entries need be made in the category-to-category relationships of the memory 34 because the corresponding links have already been created.

The third work of art is referred to as Blue Wood Carving, is a sculpture the size of a shoe, and has the color blue. No further data is available at the time of data entry, but can be added at a later time when the data becomes available. The additional data for the third work of art to be stored in the memories 32 and 34 is tabulated in Tables 3A and 3B as follows:

TABLE 3A

| ITEM | DESCRIPTOR |
|---|---|
| Blue Wood Carving | sculpture |
| Blue Wood Carving | blue |
| Blue Wood Carving | shoe |
| Blue Wood Carving | top |
| Blue Wood Carving | size |
| Blue Wood Carving | color |
| Blue Wood Carving | medium |

TABLE 3B

| PARENT CATEGORY | CHILD CATEGORY |
|---|---|
| color | blue |

The fourth work of art is referred to as clay bagel, is a sculpture made in Connecticut, has the color white, and is the size of a shoe. The additional data for the fourth work of art to be stored in the memories 32 and 34 is tabulated in Tables 4A and 4B as follows:

TABLE 4A

| ITEM | DESCRIPTOR |
|---|---|
| Clay Bagel | sculpture |
| Clay Bagel | Connecticut |
| Clay Bagel | white |
| Clay Bagel | shoe |
| Clay Bagel | size |
| Clay Bagel | color |
| Clay Bagel | location |
| Clay Bagel | top |

TABLE 4B

| PARENT CATEGORY | CHILD CATEGORY |
|---|---|
| No entry necessary | no entry necessary |

No data has been entered in the Table 4B because all of the requisite entries have already been entered into the memory 34. The data stored in the memory 34 already reflects that the works of art for which the category relationships have been entered into the memory 34 collectively present the characteristics of medium being a sculpture, of manufacture in Connecticut, of a color white, and having the size of a shoe. Therefore the information entered for the Clay Bagel would not alter the construction of the tree presented in FIG. 3 because the branches have already been constructed from the data previously entered for the other works of art.

The fifth work of art is referred to as William Coat of Arms, is a sculpture made in New York, and has the color green. The additional data for the fifth work of art to be stored in the memories 32 and 34 is tabulated in Tables 5A and 5B as follows:

TABLE 5A

| ITEM | DESCRIPTOR |
|---|---|
| William Coat of Arms | sculpture |
| William Coat of Arms | New York |
| William Coat of Arms | green |
| William Coat of Arms | black |
| William Coat of Arms | medium |
| William Coat of Arms | color |
| William Coat of Arms | location |
| William Coat of Arms | top |

TABLE 5B

| PARENT CATEGORY | CHILD CATEGORY |
|---|---|
| location | New York |
| color | green |
| color | black |

The sixth work of art is referred to as Sunflower Painting, is an oil painting made in Pennsylvania, has the color yellow, and is the size of a person. The additional data for the sixth work of art to be stored in the memories 32 and 34 is tabulated in Tables 6A and 6B as follows:

TABLE 6A

| ITEM | DESCRIPTOR |
|---|---|
| Sunflower Painting | oil |
| Sunflower Painting | Pennsylvania |
| Sunflower Painting | yellow |
| Sunflower Painting | person |
| Sunflower Painting | medium |
| Sunflower Painting | color |
| Sunflower Painting | location |
| Sunflower Painting | top |

TABLE 6B

| PARENT CATEGORY | CHILD CATEGORY |
|---|---|
| No entry necessary | no entry necessary |

No data has been entered in the Table 6B because all of the requisite entries have already been entered into the memory 34.

By way of further example, it is noted that the foregoing listing of six works of art is not the complete listing, and that further works of art are presumed to be stored in the data processor (search engine) 36 of FIG. 1. The additional works include a drawing, shown in the graph of FIG. 3, as well as additional styles of cubism and surreal, also shown in the diagram of FIG. 3.

The foregoing entry of data describing objects which may be the object of a search demonstrates a feature of the invention in which, as an initial step in the storage of data, a determination is made as to what types of descriptors, such as the properties of the desired object, would be useful in a subsequent search for leading the searcher to an object that would satisfy the goals of the search. If descriptors are employed which do not fit into existing categories, then additional categories are provided along with linkages directly to the top category or with linkages via a chain of subcategories to the top category. In the case of a work of art, the above-described descriptors are provided by way of example, and further descriptors, such as a period of time (ancient, medieval), subject matter (landscape, people, animals) and the name of the artist may be useful. In the case of a search for a work of literature, descriptors such as fiction, history, and ships would be useful. To narrow the choice of possible works during a search, subcategories would be useful, such as American, European and African, in the case of the category of history, and subcategories of sailboats, steamships and canoes, in the case of the category of ships. In all three cases of the fiction, the history and the ships, it would be useful to have subcategories of period of time of the creation of the work, and the name of the author. Also, in the choice of a suitable descriptor to be placed in the data bank of the search engine, it is the practice of the invention to select a descriptor which can be readily linked to a category or subcategory, and to select a descriptor which would apply to many possible objects of the search, but not to all objects described in the data bank. This would provide a two-fold benefit of narrowing the search to those objects which would best fulfill the needs of the searcher, while avoiding an overly large number of descriptors that might place a burden on the searcher.

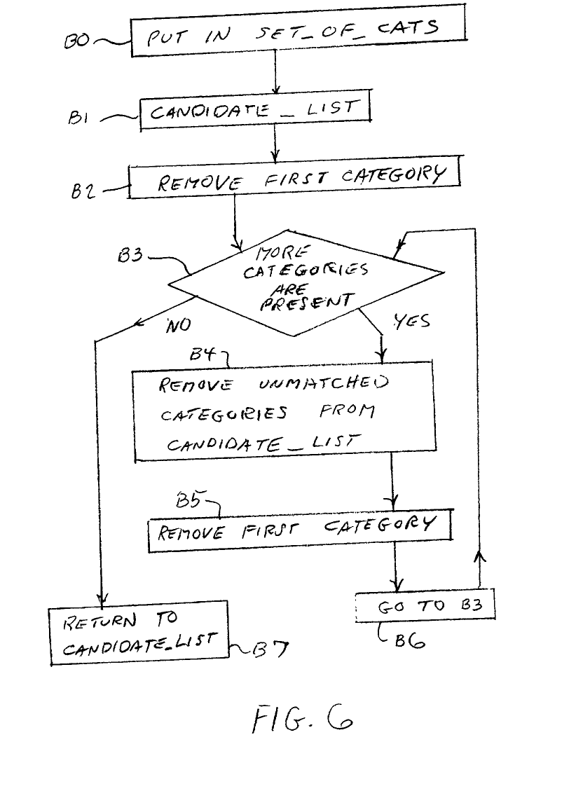

Operation of the computer 24 (FIG. 1) is explained with reference to the flow charts of FIGS. 5 and 6. With reference first to FIG. 5, the blocks are labeled A0 through A15, and steps of an algorithm for instructing the computer 24 are numbered correspondingly. In the operation of the computer 24, no distinction is made between the term “category” and the term “descriptor” and, accordingly, in the flow chart of FIG. 4 and in the following algorithm, only the term “category” appears. The algorithm reads as follows.

A0 Put the Top category in the current category state storage named CUR_STATE.

A1 If the Top category is in the CUR_STATE then GOTO A3.

A2 Add the Top category to the CUR_STATE.

A3 Put the categories that comprise the CUR_STATE in the storage named CATS.

A4 If there are no categories in CATS, GOTO A13.

A5 Remove a category from CATS and put it into the storage named A_CAT.

A6 Put all the children of the category in A_CAT in storage named CAT_CHILDS. If A_CAT is a “NOT” or “OR” category, then put no children in CAT_CHILDS.

A7 If there are no children categories in CAT_CHILDS, GOTO A4.

A8 Remove a category from CAT_CHILDS and put it into the storage named ONE_CHILD.

A9 Create a category state named NEW_STATE which is the same as CUR_STATE with A_CAT replaced by ONE_CHILD.

A10 Look at items in NEW_STATE by running a search program presented in FIG. 6 (to be described below). If at least one item is found in NEW_STATE, GOTO A11. If no items are in NEW_STATE, GOTO A12.

A11 Add NEW_STATE to the category state children list named NEW_STATES.

A12 GOTO A7.

A13 Display the NEW_STATES such that the user can select one.

A14 Search items in CUR_STATE by running the search program of FIG. 6, and display the items in CUR¹³STATE.

A15 If the user selects a new CUR_STATE from the NEW_STATES, then GOTO A1.

An example of the use of the computer 24 in the search engine 36, in accordance with the foregoing algorithm and the flowchart of FIG. 5, is presented as follows:

SAMPLE DATA of Categories and Items for the sample program:

Categories:

Top >parent of> Medium, Location

Medium >parent of> Sculpture, Oil

Location >parent of> CT, PA

Items

Clay Bagel >in categories> (Sculpture, CT, Location, Medium, Top)

Bust of Napoleon >in categories> (Sculpture, PA, Location, Medium, Top)

Blue Wood Carving >in categories> (Sculpture, Medium, Top)

Sunflower Painting >in categories> (Oil, PA, Location, Medium, Top)

Still Life Abstraction >in categories> (Oil, CT, Location, Medium, Top)

William Art Piece >in categories> (PA, Location, Top)

Here is a sample usage of the above program with the above sample data. The following example shows what the user (searcher) does and how the program is implemented by way of response.

A) The user starts the system.

B) PROGRAM: Runs from 0 to 14.

DISPLAYS:

Current Category State: (CUR_STATE)

(Top)

Children Category States: (NEW¹³STATES)

(Medium),

(Location)

Items in Category State:

Clay bagel,

Bust of napoleon,

Blue wood carving,

Sunflower painting,

Still life abstraction,

William art piece

C) The user selects (Location) (Runs 15)

D) PROGRAM: Runs 1 to 14

DISPLAYS:

Current Category State: (CUR_STATE)

(Location)

Children Category States: (NEW_STATES)

(PA, Top),

(CT, Top),

(Location, Medium)

Items in Category State:

Clay bagel,

Bust of napoleon,

Sunflower painting,

Still life abstraction,

William art piece

E) The user selects (PA, Top) (Runs 15)

F) PROGRAM: Runs 1 to 14

DISPLAYS:

Current Category State: (CUR_STATE)

(PA, Top)

Children Category States: (NEW_STATES)

(PA, Sculpture),

(PA, Location)

Items in Category State:

Bust of napoleon,

Sunflower painting,

William art piece

G) The user selects (PA, Medium) (Runs 15)

H) PROGRAM: Runs 1 to 14

DISPLAYS:

Current Category State: (CUR_STATE)

(PA, Medium)

Children Category States: (NEW_STATES)

(PA, Sculpture, Top),

(PA, Oil, Top)

Items in the Current Category State:

Bust of napoleon,

Sunflower painting,

I) The user selects (PA, Oil, Top) (Runs 15)

J) PROGRAM: Runs 1 to 15

DISPLAYS:

Current Category State: (CUR_STATE)

(PA, Oil, Top)

Children Category States: (NEW_STATES)

(PA, Oil, Medium),

(PA, Oil, Location)

Items in the Current Category State:

Sunflower painting

K) At this stage, this user is satisfied with his search results and evaluates the sunflower painting.

In FIG. 6, the blocks of the flow chart are labeled B0 through B7, and steps of a corresponding algorithm for instructing the computer 24 are numbered correspondingly. The algorithm is an item category search algorithm, and reads as follows:

B0 Put the set of categories to search in the storage named SET_OF_CATS.

B1 Put the items associated with the first category named in SET_OF_CATS into the storage named CANDIDATE_LIST. The CANDIDATE_LIST is a listing of items meeting the restrictions imposed by the searcher.

B2 Remove the first category from SET_OF_CATS.

B3 If there are no more categories, then GOTO B7.

B4 Remove all items from CANDIDATE_LIST that are not in the first category in SET_OF_CATS. Do this by searching the item to category (descriptor) tabulation (Table A1+A2 . . . +A6) for records with the first category and each item in the CANDIDATE_LIST. In the case of a selection of an OR function by the searcher, check each category that is part of the OR function before removing an item from the CANDIDATE_LIST. For example, if the colors black and blue are part of the OR function, perform the search for black, and then perform the search for blue. In the case of selection of a NOT function by the searcher, for example, NOT black, perform the search for black but with a removing of the black items from the CANDIDATE_LIST.

B5 Remove the first category from SET_OF_CATS.

B6 GOTO B3.

B7 RETURN to CANDIDATE_LIST.

The foregoing algorithms demonstrate how the computer 24 (FIG. 1) is programmed to cycle through numerous entries stored in the memories 32 and 34 of the data processor 36 to provide objects which meet the goals of a user of the search station 20 or of the search station 38 (FIG. 2).

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A process for navigating through categories of data in the conduction of a search for identifiable items, comprising the steps of:
storing identities and descriptors of items to be accessible by a search;
establishing a first set of data categories which serve to group individual ones of the descriptors of the items, the establishing of the first set of categories including a generating of a first set of relationships between the categories of the first set and the descriptors of the items;
establishing a second set of data categories which serve to group individual ones of the categories of the first set of categories, the establishing of the second set of categories including a generating of a second set of relationships between the categories of the second set and the categories of the first set;
characterizing an item, by its descriptors, to be an object of the search; and
selecting a plurality of categories drawn from one or both of said sets of categories in any of multiple orders to produce a sequence of categories, wherein at least one category of said sequence of categories relates to descriptors of the object.

2. A process according to claim 1 wherein, in said selecting step, in said sequence of categories, there are at least two sequential categories of which a latter category restricts a range of object descriptors of a former category by a Boolean intersection.

3. A process according to claim 2 further comprising steps of:
displaying, via a display, a list of individual ones of said categories of said first and said second sets of categories available for use in construction of said sequence in said selecting step, said displaying step including a displaying, via said display, of categories in said sequence; and
withdrawing from the list a category which has been negated by a category in the sequence.

4. A process according to claim 2 further comprising steps of:
displaying, via a display, a list of individual ones of said categories of said first and said second sets of categories available for use in construction of said sequence in said selecting step, said displaying step including a displaying, via said display, of categories in said sequence; and
withdrawing from the list a category which represents a null set of object descriptors.

5. A process according to claim 1 further comprising steps of:
choosing at least one of said descriptors;
displaying, via a display, a list of individual ones of said categories of said first and said second sets of categories available for use in construction of said sequence in said selecting step, said displaying step including a displaying, via said display, of categories in said sequence and chosen ones of said descriptors; and
indicating which of said descriptors has been chosen.

6. A process according to claim 5 further comprising a step of negating a chosen one of said descriptors.

7. A process according to claim 1 wherein said selecting step includes a step of choosing from at least two possible selections concurrently with a choosing of an OR function, said selections being drawn from said descriptors and from categories of said first and said second data categories.

8. A process for navigating through categories of data in the conduction of a search for identifiable items, wherein a memory stores identities and descriptors of the items, and wherein there is a first set of data categories which serve to group individual ones of the descriptors of the items via a first set of relationships among the categories of the first set and the descriptors of the items, and the memory stores the first set of relationships, furthermore wherein there is a second set of data categories which serve to group individual ones of the categories of the first set of categories via a second set of relationships among the categories of the second set and the categories of the first set, and the memory stores the second set of relationships, the process comprising the steps of:
characterizing an item, by its descriptors, to be an object of the search; and
selecting a plurality of categories drawn from one or both of said sets of categories in any of multiple orders to produce a sequence of categories, wherein at least one category of said sequence of categories relates to descriptors of the object.

9. A process according to claim 8 wherein, in said selecting step, in said sequence of categories, there are at least two sequential categories of which a latter category restricts a range of object descriptors of a former category by a Boolean intersection.

10. A process according to claim 9 further comprising steps of:
displaying, via a display, a list of individual ones of said categories of said first and said second sets of categories available for use in construction of said sequence in said selecting step, said displaying step including a displaying, via said display, of categories in said sequence; and
withdrawing from the list a category which has been negated by a category in the sequence.

11. A process according to claim 9 further comprising steps of:
displaying, via a display, a list of individual ones of said categories of said first and said second sets of categories available for use in construction of said sequence in said selecting step, said displaying step including a displaying, via said display, of categories in said sequence; and
withdrawing from the list a category which represents a null set of object descriptors.

12. A process according to claim 8 further comprising steps of:
choosing a t least one of said descriptors;
displaying, via a display, a list of individual ones of said categories of said first and said second sets of categories available for use in construction of said sequence in said selecting step, said displaying step including a displaying, via said display, of categories in said sequence and chosen ones of said descriptors; and
indicating which of said descriptors has been chosen.

13. A process according to claim 12 further comprising a step of negating a chosen one of said descriptors.

14. A process according to claim 8 wherein said selecting step includes a step of choosing from at least two possible selections concurrently with a choosing of an OR function, said selections being drawn from said descriptors and from categories of said first and said second sets of data categories.

15. A search system comprising a search engine, a display communicating with the engine, and data entry means communicating with the display and the engine, the system enabling a searcher to navigate through categories of data in the conduction of a search for identifiable items, wherein the engine comprises:
a memory for storing identities and descriptors of items to be accessible by a search;
wherein the memory also stores a first set of data categories which serve to group individual ones of the descriptors of the items, and a first set of relationships between the categories of the first set and the descriptors of the items;
wherein the memory also stores a second set of data categories which serve to group individual ones of the categories of the first set of categories, and a second set of relationships between the categories of the second set and the categories of the first set;
wherein the display presents choices of the categories to the searcher, and the data entry means enable the searcher to select a plurality of categories drawn from one or both of said sets of categories in any of multiple orders to produce a sequence of categories, wherein at least one category of said sequence of categories relates to descriptors of one of said items being sought by the searcher.

16. A system according to claim 15 wherein each of said relationships is a parent-child relationship.

17. A system according to claim 15 wherein said display and said engine are located at a common location.

18. A system according to claim 15 wherein said display and said engine are located at separate locations, and means are provided for communication of data between said engine and said display.

19. A system according to claim 15 wherein said engine includes a computer that monitors progress of the searcher in choosing a succession of the categories, the computer commanding the display to list categories available for choosing, and to withdraw categories leading to a null set of items.

20. A system according to claim 15 wherein said data entry means enables entry of a request to negate one of said descriptors for identifying one of said items.

21. A system according to claim 15 wherein said data entry means enables entry of a plurality of chosen ones of said descriptors for identifying one of said items characterized by a Boolean intersection of said plurality of chosen descriptors.

22. A system according to claim 15 wherein said data entry means enables entry of a plurality of selections for identifying one of said items characterized by a Boolean OR of said plurality of selections, said selections being drawn from said descriptors and from categories of said first and said second sets of data categories.

23. A process for navigating through a set of categories of data in the conduction of a search for identifiable items, comprising the steps of:
storing identities and descriptors of items to be accessible by a search, the storing establishing a first set of relationships between the items and their respective descriptors;
establishing a second set of relationships which serves to relate individual ones of the data categories to each other and to the descriptors hierarchically, the second set of relationships being constructed in plural branches of a hierarchical tree; and
implementing a sequence of selections in any one of a multiplicity of orders from a set of available selections to obtain the identity of at least one of said items, said available selections being drawn from said categories and from said descriptors and from plural branches of said hierarchical tree.

24. A process according to claim 23 wherein said implementing step includes a step of negating subject matter in one of said selections.

25. A process according to claim 23 wherein said implementing step includes a step of introducing an OR function between two selections of said sequence.

26. A process for navigating through a set of categories of data in the conduction of a search for identifiable items, wherein a memory stores identities and descriptors of items to be accessible by a search, the storing establishing a first set of relationships between the items and their respective descriptors, and the memory stores a second set of relationships which serves to relate individual ones of the data categories to each other and to the descriptors hierarchically, the second set of relationships being constructed in plural branches of a hierarchical tree; the process comprising steps of:
selecting a category of subject matter describing an object of the search; and
implementing a sequence of selections in any one of a multiplicity of orders from a set of available selections to obtain the identity of at least one of said items, said available selections being drawn from said categories and from said descriptors and from plural branches of said hierarchical tree.

27. A process according to claim 26 wherein said implementing step includes a step of negating subject matter in one of said selections.

28. A process according to claim 26 wherein said implementing step includes a step of introducing an OR function between two selections of said sequence.

29. A search system comprising a search engine and a memory, the memory storing identities and descriptors of items to be accessible by a search, and including a first set of relationships between the items and their respective descriptors, the memory storing a second set of relationships which serves to relate individual ones of the data categories to each other and to the descriptors hierarchically, the second set of relationships being constructed in a fashion of plural branches of a hierarchical tree;
wherein the system is operative with a display and data entry means communicating with the display and the engine, wherein the engine communicates information to the display enabling the display to present choices of the categories stored in the memory to a searcher, and said data entry means cooperates with said engine to enable the searcher during the conduct of a search to implement a sequence of selections in any one of a multiplicity of orders from a set of available selections to obtain the identity of at least one of said items, said available selections being drawn from said categories and from said descriptors and from plural branches of said hierarchical tree.

30. A system according to claim 29 wherein said engine, under command of the searcher negates subject matter in one of said selections.

31. A system according to claim 29 wherein said engine, under command of the searcher introduces an OR function between two selections of said sequence.
